(19) United States
(12) Patent Application Publication
(10) Pub. No.: US 2026/0189771 A1
(43) Pub. Date: Jul. 2, 2026

(54) VIDEO PROCESSING METHOD AND APPARATUS, AND ELECTRONIC DEVICE

(71) Applicant: Beijing Zitiao Network Technology Co., Ltd., Beijing (CN)

(72) Inventors: Li TANG, Beijing (CN); Hao DONG, Beijing (CN); Zhiming HE, Beijing (CN); Huan XIA, Beijing (CN); Lei ZHAI, Beijing (CN); Yating LIU, Beijing (CN); Jingcheng HUANG, Beijing (CN); Ji LI, Beijing (CN); Jing SHEN, Beijing (CN); Zehua LIU, Beijing (CN)

(21) Appl. No.: 19/416,708

(22) Filed: Dec. 11, 2025

(30) Foreign Application Priority Data
Dec. 30, 2024 (CN) 202411982887.9

(51) Int. Cl. H04N 21/845; G11B 20/10

(52) U.S. Cl. CPC H04N 21/845; G11B 20/10

(57) ABSTRACT

The embodiments of the present disclosure provide a video processing method and apparatus, and an electronic device. The video processing method includes: acquiring a first video and first information, where the first information is used for generating a second video, and the first information comprises an identifier of an audio and editing information; acquiring the audio in a content delivery network based on the identifier of the audio; and generating the second video based on the first video, the audio, and the editing information.

### CROSS-REFERENCE TO RELATED APPLICATIONS

The present application is based on and claims priority of CN Application No. 202411982887.9, filed on Dec. 30, 2024, the disclosure of which is incorporated by reference herein in its entirety.

### TECHNICAL FIELD

Embodiments of the present disclosure relate to the technical field of multimedia, and in particular, to a video processing method and apparatus, and an electronic device.

### BACKGROUND

In a video posting process, a user can select background music to be added to a video, and after the background music is added to the video, the user can post the video.

### SUMMARY

The embodiments of the present disclosure provide a video processing method and apparatus and an electronic device, for solving the technical problems in the prior art.

In a first aspect, an embodiment of the present disclosure provides a video processing method, including acquiring a first video and first information, where the first information is used for generating a
second video, and the first information includes an identifier of an audio and editing information; acquiring the audio in a content delivery network based on the identifier of the audio; and generating the second video based on the first video, the audio, and the editing information.

In a second aspect, an embodiment of the present disclosure provides a video processing apparatus, including a first acquisition module, a second acquisition module, and a generation module, where:
the first acquisition module is configured to acquire a first video and first information, where the first information is used for generating a second video, and the first information includes an identifier of an audio and editing information;
the second acquisition module is configured to acquire the audio in a content delivery network based on the identifier of the audio; and
the generation module is configured to generate the second video based on the first video, the audio, and the editing information.

In a third aspect, the present disclosure provides a terminal device including: a processor and a memory; where
the memory stores computer-executable instructions;
the processor executes the computer-executable instructions stored by the memory, to cause the at least one processor to perform the video processing method of the first aspect or possibly involved in the first aspect.

In a fourth aspect, the present disclosure provides a computer-readable storage medium having stored therein computer-executable instructions which, when executed by a processor, implement the video processing method of the first aspect or possibly involved in the first aspect.

In a fifth aspect, the present disclosure provides a computer program product including a computer program which, when executed by a processor, implements the video processing method of the first aspect or possibly involved in the first aspect.

### BRIEF DESCRIPTION OF THE DRAWINGS

In order to more clearly illustrate the embodiments of the present disclosure or the technical solutions in the prior art, the drawings used in the description of the embodiments or the prior art will be briefly described below, and it is obvious that the drawings in the following description are some embodiments of the present disclosure, and those skilled in the art can obtain other drawings from these drawings without creative labor.

FIG. 1 is a schematic diagram of an application scenario according to an embodiment of the present disclosure;

FIG. 2 is a schematic flowchart of a video processing method according to an embodiment of the present disclosure;

FIG. 3 is a schematic diagram of a first video according to an embodiment of the present disclosure;

FIG. 4 is a schematic diagram of another first video according to an embodiment of the present disclosure;

FIG. 5 is a schematic diagram of a process of acquiring a first video according to an embodiment of the present disclosure;

FIG. 6 is a schematic diagram of a process of acquiring an audio according to an embodiment of the present disclosure;

FIG. 7 is a schematic diagram of a process of generating a second video according to an embodiment of the present disclosure;

FIG. 8 is a schematic diagram of a method of generating a second video according to an embodiment of the present disclosure;

FIG. 9 is a schematic structural diagram of a video processing apparatus according to an embodiment of the present disclosure;

FIG. 10 is a schematic structural diagram of an electronic device according to an embodiment the present disclosure.

### DETAILED DESCRIPTION

Reference will now be made in detail to the exemplary embodiments, examples of which are illustrated in the accompanying drawings. The following description refers to the accompanying drawings in which the same numbers in different drawings represent the same or similar elements unless otherwise indicated. The implementations described in the following exemplary embodiments do not represent all implementations consistent with the present disclosure. Rather, they are merely examples of apparatuses and methods consistent with certain aspects of the present disclosure, as detailed in the appended claims.

It is understood that, before the technical solutions disclosed in the embodiments of the present disclosure are used, the user should be informed of the type, use range, use scene, etc. of personal information related to the present disclosure in a proper manner according to relevant laws and regulations and the authorization of the user should be obtained.

For example, in response to receiving a user's active request, a prompt is sent to the user to explicitly prompt the user that the requested operation to be performed would require acquisition and use of the personal information of the user. Thus, the user can autonomously select whether to provide the personal information to software or hardware such as a terminal device, an application program, a server, or a storage medium that performs the operation of the technical solution of the present disclosure, according to the prompt.

As an alternative but non-limiting implementation, in response to receiving an active request from the user, the manner of sending the prompt to the user may be, for example, a pop-up window manner, and the prompt may be presented in a text manner in the pop-up window. In addition, a selection control for the user to select ‘agree’ or ‘disagree’ providing the personal information to the terminal device can be carried in the popup window.

It is understood that the above information and user authorization process is only illustrative and is not intended to limit the implementation of the present disclosure, and other ways of satisfying the relevant laws and regulations may be applied to the implementation of the present disclosure.

For ease of understanding, the following description will explain concepts related to the embodiments of the present disclosure.

Edge node: an edge node refers to an interface node between an edge device and a cloud computing resource, in an edge computing architecture. The edge node can be used for realizing functions such as edge calculation, data transmission, and management. For example, an edge node may be a high-performance, low-latency, low-consumption hardware device, and the edge node may implement tasks such as data processing, caching, preprocessing in an edge computing scenario.

The edge node may be deployed in a location such as an edge device, an Internet of Things endpoint, a wireless sensor network, a vehicle gateway. The edge node can perform wireless communication and data exchange with a cloud computing center and can also interact and cooperate with devices and networks near the edge node. Because the edge node can realize high-efficiency transmission and analysis of data from device to cloud, the transmission delay and bandwidth consumption can be reduced, improving the data processing efficiency and response speed.

Currently, after the user selects the background music, a terminal device may download the background music in a server, and after the terminal device re-encodes the video and the background music, may send the posted video to the server. However, in the above method, the terminal device may fail to re-encode the video and the background music, resulting in a low success rate of video posting.

The embodiments of the present disclosure provide a video processing method and apparatus and an electronic device, where the electronic device can acquire a first video and first information, the first information can be used for generating a second video, the first information includes an identifier of an audio and editing information, and the electronic device can acquire the audio in a content delivery network based on the identifier of the audio and generate the second video based on the first video, the audio and the editing information. In the method, since the electronic device can acquire the audio in the content delivery network, the terminal device is not required to download and then upload the audio, saving communication resources, shortening the time required by video generation, improving the video posting efficiency, and, the second video is generated at the electronic device, improving the success rate of re-encoding the video and background music, thereby further improving the success rate of video posting.

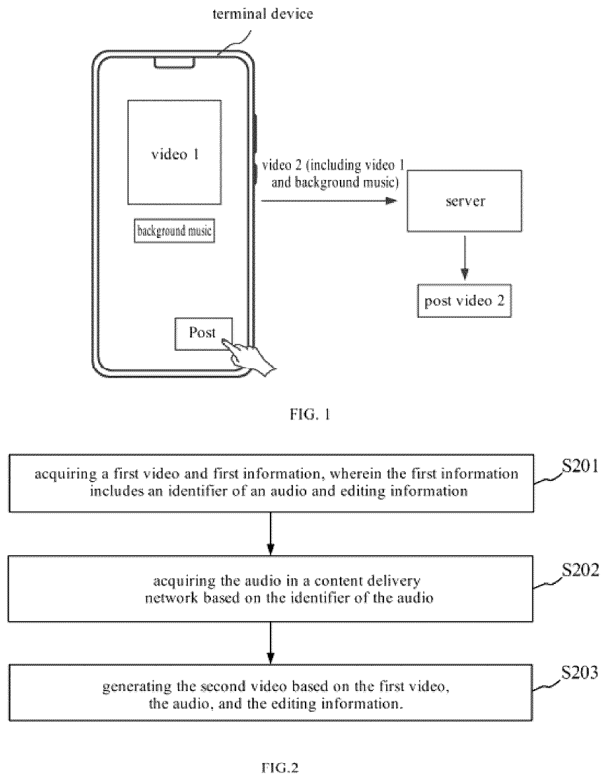

Next, an application scenario of an embodiment of the present disclosure is described with reference to FIG. 1.

FIG. 1 is a schematic diagram of an application scenario according to an embodiment of the present disclosure. Please refer to FIG. 1, which includes a terminal device and a server. The page displayed by the terminal device is a posting page of a video, and the posting page of the video includes a video 1 selected by a user, background music of the video 1 and a Post control. After the user clicks the Post control, the terminal device may re-encode the video 1 and the background music to obtain a video 2, where the video 2 includes the video 1 and the background music. The terminal device may send the video 2 to the server. After the server receives the video 2, the video 2 may be posted.

In the related art, in the video posting process, a terminal device may add background music to a video created by a user and post a video including the background music. At present, after a user selects background music, a terminal device may download the background music, re-encode the background music and a video created by the user to obtain a new video, the terminal device may send the new video to a server, and the server may post the new video.

For example, in response to a selection of the user, a client may download the background music selected by the user, and re-encode the background music and the video locally to obtain a new video, the client may upload the new video to the server, and the server may post the new video. However, in the above method, the terminal device needs to download and then upload the background music, resulting in waste of communication resources, and longer time required for video generation, and when the performance of the terminal device is insufficient, the success rate of locally re-encoding the background music and the video by the terminal device is low, resulting in a low success rate of video posting.

In order to solve the technical problems in the related art, an embodiment of the present disclosure provides a video processing method, where an electronic device may receive a plurality of video segments sent by a terminal device, and first information, and merge the plurality of video segments to obtain a first video, the electronic device may acquire an audio in a content delivery network based on an identifier of an audio, and acquire a material indicated by editing information based on the editing information, and the electronic device may generate a second video based on the editing information, the material, the first video, and the audio.

In the method, since the electronic device can receive the plurality of video segments of the first video, when any one video segment fails to be received, the electronic device can receive the video segment again, and the terminal device does not need to resend the complete video, and since the terminal device does not need to download and then upload the audio, communication resources can be saved, the time required by video generation can be reduced, the video posting efficiency can be improved, and since the second video is generated at the electronic device, the success rate of re-encoding the video and background music can be improved, thereby further improving the success rate of video posting.

The following describes the technical solutions of the present disclosure and how they solve the above technical problems in detail with specific embodiments. These several specific embodiments may be combined with each other below, and details of the same or similar concepts or processes may not be repeated in some embodiments. The embodiments of the present disclosure will be described below with reference to the accompanying drawings.

FIG. 2 is a schematic flowchart of a video processing method according to an embodiment of the present disclosure. Referring to FIG. 2, the method may include:
S201, acquiring a first video and first information, where the first information includes an identifier of an audio and editing information.

The execution subject of the embodiment of the present disclosure may be an electronic device, and may also be a video processing apparatus provided in the electronic device. The video processing apparatus may be implemented based on software, or the video processing apparatus may also be implemented based on a combination of software and hardware, which is not limited in this disclosure.

The electronic device may be any device with computing power. For example, the electronic device may be a computer, a server, an edge node, and the like, which is not limited in this disclosure.

The first video may be a video recorded by the terminal device. For example, a page of the terminal device may include a Record control, the terminal device may record a video in response to the user touching the Record control, and after a period of time, the terminal device may stop recording the video in response to the user touching the Record control again, so as to obtain the first video.

The first video may be a video created by a user. For example, the terminal device may record a video, and the user may edit the video to obtain the first video. For example, the terminal device may record 30 seconds of video, and the user may clip 5 seconds of video in the video to obtain the first video.

For example, the terminal device may receive a video segment sent by another device, and the user may edit the video segment to obtain the first video. For example, another device may send a 30-second video to the terminal device, and the user may clip 10 seconds of video in the video to obtain the first video.

In some embodiments, the first video may be a video that the electronic device receives from another device. For example, after the terminal device determines the first video, the first video may be transmitted to the electronic device.

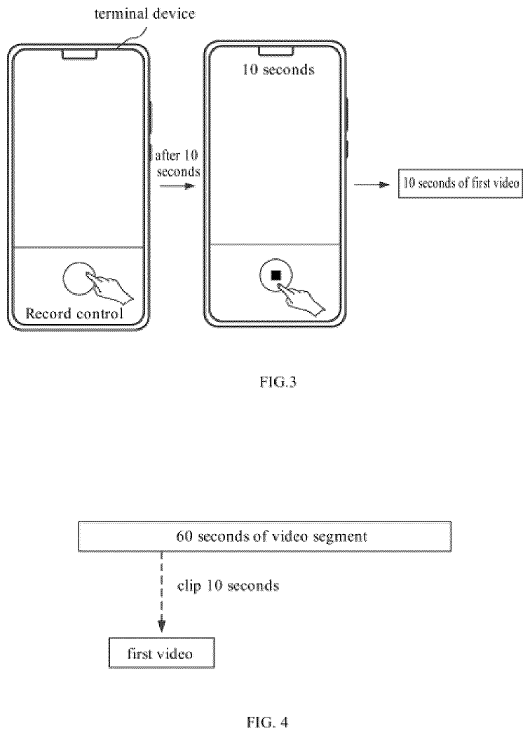

Next, a process of determining the first video by the terminal device is described with reference to FIG. 3 to 4.

FIG. 3 is a schematic diagram of a first video according to an embodiment of the present disclosure. Please refer to FIG. 3, which includes: a terminal device. The page displayed by the terminal device is a recording page in which a Record control is included. When the user clicks the Record control, the terminal device starts to record a video. After 10 seconds, the user clicks the Record control again, the terminal device stops recording the video, and 10 seconds of video is obtained.

The terminal device may determine the recorded 10-second video as a first video, and transmit the first video to the electronic device.

FIG. 4 is a schematic diagram of another first video according to an embodiment of the present disclosure. Please refer to FIG. 4, which includes: a 60-second video segment. The video segment may be a video segment stored in a terminal device (not shown in FIG. 4). The user can clip 10 seconds of video in the 60-second video segment.

The terminal device may determine the clipped 10-second video as the first video and transmit the first video to the electronic device.

The first information may be used to generate a second video. The second video may be a video to be generated. For example, the second video is a video generated based on the first video and the first information.

In some embodiments, the second video may be a video generated based on content of the first video and the first information. For example, the second video may be a video obtained by adding background music to the first video. For example, the second video may be a video obtained after editing the first video and adding background music thereto.

The first information may include an identifier of an audio and editing information.

Optionally, the first information may include an identifier of an audio but not editing information, and the first information may include editing information but not an identifier of an audio.

The audio may be used to generate a second video. For example, the audio may be background music of the second video. For example, the identifier of the audio may be a name of the audio, an author of the audio, and the like, which is not limited by the embodiment of the present disclosure. For example, the background music includes music 1, music 2, and music 3, and if the user selects music 1 as the background music of the second video, the terminal device may determine an identifier of music 1 as the identifier of the audio in the first information, if the user selects music 2 as the background music of the second video, the terminal device may determine an identifier of music 2 as the identifier of the audio in the first information, and if the user selects music 3 as the background music of the second video, the terminal device may determine an identifier of music 3 as the identifier of the audio in the first information.

The editing information may be used to generate a second video. For example, since the second video is generated on the basis of the first video, the editing information may be editing information for the first video. For example, the editing information may include an editing operation by the user to crop, segment, add text, add a sticker, add a filter, add an effect, add a variable speed etc. for the first video.

The electronic device may acquire the first video and the first information based on the following feasible implementations: receiving a plurality of video segments and the first information sent by the terminal device, where the terminal device can merge the plurality of video segments to obtain the first video.

In this way, transmission delay can be reduced, each video segment can be independently transmitted, the transmission speed is increased, and, in the transmission process, if any video segment fails to be transmitted, the terminal device can retransmit the video segment without retransmitting the complete first video, improving the transmission success rate.

In some embodiments, the terminal device may determine a data model for generating the second video and determine the first information based on the data model.

Illustratively, the terminal device may construct a data model for the second video, the data model may describe a draft (a preliminarily edited version or an unposted version in a video editing process) structure edited by the user, the data model may include a name of background music of the second video, a length of the second video, a description of the second video (a brief summary of video content, which facilitates other users to quickly understand the video content), and editing information, and the terminal device may determine the first information in the data model and transmit the first information to the electronic device.

In some embodiments, after determining the data model for generating the second video, the terminal device may also send the data model to the electronic device, and the electronic device may parse the data model to obtain the first information for generating the second video.

Optionally, the electronic device may also receive editing information of the first video sent by the terminal device. For example, after the user edits the first video, the terminal device may store the editing information of the first video and send the editing information to the edge node.

Optionally, the electronic device may also determine the editing information (for example, parsing the first video to obtain the editing information) based on any feasible implementation, which is not limited in the embodiment of the present disclosure.

Optionally, the terminal device may construct the data model of the second video based on any feasible implementation, which is not limited in this disclosure.

Next, a process of acquiring the first video by the electronic device is described with reference FIG. 5.

FIG. 5 is a schematic diagram of a process of acquiring a first video according to an embodiment of the present disclosure. Please refer to FIG. 5, which includes a terminal device and an edge node. After the terminal device determines the first video, the first video may be divided into video segment 1, video segment 2, . . . , and video segment n.

Referring to FIG. 5, the terminal device may send video segment 1, video segment 2, . . . , and video segment n to the edge node, and the edge node may cache the video segment 1, the video segment 2, . . . , and the video segment n, and obtain the first video according to the video segment 1, the video segment 2, . . . , and the video segment n.

Optionally, after the electronic device enables a function of receiving the video in segments, the terminal device may divide the first video into a plurality of video segments, and send the plurality of video segments to the electronic device. For example, if the electronic device does not enable the function of receiving the video in segments, the terminal device may send a complete first video to the electronic device, and if the electronic device enables the function of receiving the video in segments, the terminal device may send a plurality of video segments determined based on the first video to the electronic device, thereby improving flexibility of video transmission.

Optionally, after the electronic device receives the plurality of video segments, the plurality of video segments may be stored in a cache, and when the electronic device generates the second video, the electronic device may acquire the plurality of video segments from the cache and merge the plurality of video segments into the first video. In this way, management of storage space can be optimized, storage space is saved, and due to the fact that the electronic device can merge the plurality video segments into the first video to process, time consumption of processing the video segments one by one can be avoided, reducing time consumption of video generation, and improving efficiency of video generation.

In some embodiments, before the terminal device transmits the first video and the first information to the electronic device, the terminal device may determine whether to transmit the first video and the first information to the electronic device. For example, the terminal device may determine a time consumed for transmitting the first video to the electronic device, and if the time consumed is long and is greater than a time consumed for the terminal device to re-encode the first video and the background music locally, the terminal device may generate the second video locally, that is, the terminal device determines that it is not needed to transmit the first video and the first information to the electronic device, and if the time consumed is short or is less than the time consumed for the terminal device to re-encode the first video and the background music locally, the terminal device may transmit the first video and the first information to the electronic device, and the electronic device generates the second video.

Illustratively, if a data amount of the first video is greater than or equal to a first threshold (which may be an arbitrarily set value), it indicates that a long time is consumed for the terminal device to transmit the first video, and therefore, the terminal device may not transmit the first video and the first information to the electronic device, and the terminal device may generate the second video based on the first video and the first information; and if the data amount of the first video is less than the first threshold, it indicates that a short time is consumed for the terminal device to transmit the first video, and the terminal device may transmit the first video and the first information to the electronic device, and the electronic device generates the second video based on the first video and the first information.

Illustratively, if a network delay (or packet loss rate) is greater than or equal to a second threshold, it indicates that a longer time is consumed for the terminal device to transmit the first video, the terminal device may not transmit the first video and the first information to the electronic device, and the terminal device may generate the second video based on the first video and the first information; and if the network delay (or packet loss rate) is less than the second threshold, it indicates that a shorter time is consumed for the terminal device to transmit the first video, the terminal device may transmit the first video and the first information to the electronic device, and the electronic device generates the second video based on the first video and the first information.

Illustratively, if a power consumption of the terminal device is greater than or equal to a third threshold, it indicates that a success rate of re-encoding the first video and the background music by the terminal device is low, and therefore, the terminal device may transmit the first video and the first information to the electronic device, and the electronic device may generate the second video based on the first video and the first information; and if the power consumption of the terminal device is less than the third threshold, it indicates that the success rate of re-encoding the first video and the background music by the terminal device is high, and therefore, the terminal device may not transmit the first video and the first information to the electronic device, and the terminal device may generate the second video based on the first video and the first information.

Illustratively, if a temperature of the terminal device is greater than or equal to a fourth threshold, it indicates that the terminal device may be stuck, the success rate of re-encoding the first video and the background music by the terminal device is low, and therefore, the terminal device may transmit the first video and the first information to the electronic device, and the electronic device may generate the second video based on the first video and the first information; and if the temperature of the terminal device is less than the fourth threshold, it indicates that the terminal device is less probably stuck, and therefore, the terminal device may not transmit the first video and the first information to the electronic device, and the terminal device may generate the second video based on the first video and the first information.

In some embodiments, if the user does not perform an editing operation on the first video after selecting the background music, the terminal device may transmit the first video and the first information to the electronic device.

Illustratively, if a user does not perform an editing operation such as cropping, segmenting, adding text, adding a sticker, adding a filter, adding an effect, adding a variable speed, and the like on the first video, the terminal device may transmit the first video and first information to an edge node, and if the user performs an editing operation such as cropping, segmenting, adding text, adding a sticker, adding a filter, adding an effect, adding a variable speed, and the like on the first video, the terminal device may or may not transmit the first video and the first information to the edge node, which is not limited in the embodiment of this disclosure, so that flexibility in generating the second video can be improved.

It should be noted that, the above methods for the terminal device to determine whether to transmit first video and the first information to the electronic device may be combined, which is not limited in this disclosure.

S202, acquiring the audio in a content delivery network based on the identifier of the audio.

The electronic device may acquire the audio in a Content Delivery Network (CDN) based on the identifier of the audio. For example, the content delivery network includes music 1 and music 2, and if the identifier of the audio is an identifier of music 1, the electronic device may acquire music 1 in the content delivery network, and if the identifier of the audio is an identifier of music 2, the electronic device may acquire music 2 in the content delivery network.

In some embodiments, if the terminal device sends a data model of the second video to the electronic device, the electronic device may parse the data model to obtain background music of the second video, and pull the resource of the background music from the CND, so that the terminal device does not need to download and then upload the background music, saving communication resources, reducing the time consumed for video generation, and improving the video generation efficiency.

The CDN may cache and distribute content in servers (e.g., edge nodes) deployed in different geographic locations. When a user requests to access resources, the user request can be redirected to an edge node closest to the user, the cached content is provided, reducing the delay of data transmission.

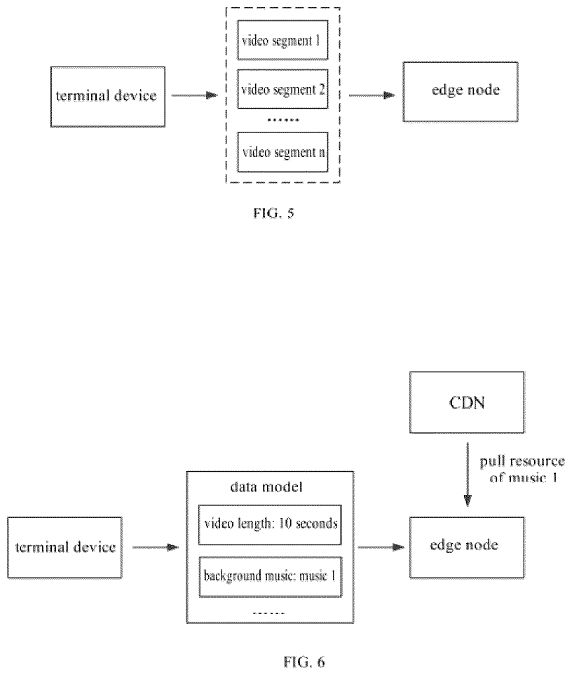

Next, with reference to FIG. 6, a process of acquiring an audio by an electronic device will be described.

FIG. 6 is a schematic diagram of a process of acquiring an audio according to an embodiment of the present disclosure. Please refer to FIG. 6, which includes a terminal device, an edge node and a CDN. The terminal device may send to the edge node a data model, in which information associated with generating the second video: video length: 10 seconds; background music: music 1, etc., may be included. The edge node may determine, based on the data model, that the background music of the second video is music 1, and pull the resource of music 1 in the CDN. This can save communication resources, reduce the time consumption of video generation, and improve the video generation efficiency.

S203, generating a second video based on the first video, the audio and the editing information.

In some embodiments, when the first information does not include the editing information, the electronic device may re-encode the first video and the background music to obtain the second video. For example, the electronic device may re-encode the first video and the audio according to the content described by the data model to obtain the second video, where the video content of the second video is the first video, and the background music of the second video is the audio.

In some embodiments, when the first video includes the editing information, the electronic device may edit the first video according to the editing information, and re-encode the editing result and the audio to obtain the second video.

After the terminal device generates the second video, the second video can be stored and posted. For example, after the electronic device generates the second video, the second video may be stored in a object store and posted, and other terminal devices may browse the second video based on the server, so that the security of the data may be improved, and the efficiency of data access may be improved.

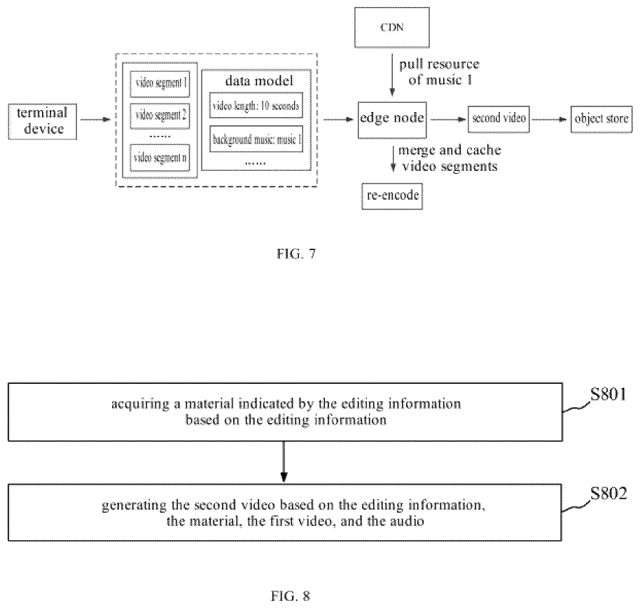

Next, a process of generating the second video will be described with reference to FIG. 7.

FIG. 7 is a schematic diagram of a process of generating a second video according to an embodiment of the present disclosure. Please refer to FIG. 7, which includes: a client, an edge node, a CDN, a cache and a object store, where the terminal device may send a data model and video segments of the first video to the edge node. The data model may include information associated with generating the second video, such as video length: 10 seconds; background music: music 1. The video segments of the first video may include video segment 1, video segment 2, . . . , video segment n.

Referring to FIG. 7, the edge node may determine that the background music of the second video is music 1 based on the data model, and pull the resource of music 1 in the CDN. The edge node may cache the video segments in the cache and the first video formed after merging the video segments. The edge node may re-encode the music 1 and the first video determined based on the plurality of video segments, based on the data model to obtain a second video, and store the second video in the object store. In this way, the terminal device does not need to download and then upload the music 1, saving communication resources, and the edge node can rapidly generate the second video, improving the efficiency of generating the second video.

The embodiment of the present disclosure provides a video processing method, in which an electronic device may receive a plurality of video segments transmitted by a terminal device and first information, merge the plurality of video segments to obtain a first video, and acquire an audio in a content delivery network based on an identifier of the audio, and generate a second video based on the first video, the audio, and editing information in the first information. In the method, since the terminal device does not need to download the audio or send the audio to the electronic device, communication resources can be saved, the time consumption for processing the audio and the video is reduced, the video generation efficiency is improved, and since the second video is generated at the electronic device, the success rate of re-encoding the first video and the audio can be improved, and the success rate of video posting is improved.

On the basis of the embodiment shown in FIG. 2, a method for the electronic device to generate a second video based on the first video, the audio and the editing information in the video processing method will be described in detail below with reference to FIG. 8.

FIG. 8 is a schematic diagram of a method of generating a second video according to an embodiment of the present disclosure. Referring to FIG. 8, the method includes:
S801, acquiring a material indicated by the editing information based on the editing information.

The material may be a material corresponding to the editing information. For example, the material may include a material such as a filter, effect, sticker, and text. For example, the material may include one or more of: video, image, audio, sticker, filter, effect, text.

For example, if the editing information indicates that a video is added to the first video, the material indicated by the editing information may be the video; if the editing information indicates that an image is added to the first video, the material indicated by the editing information may be the image; if the editing information indicates that an audio is added to the first video, the material indicated by the editing information may be the audio; if the editing information indicates that a filter is added to the first video, the material indicated by the editing information may be the filter; if the editing information indicates that an effect is added to the first video, the material indicated by the editing information may be the effect; if the editing information indicates that text is added to the first video, the material indicated by the editing information may be the text; and if the editing information indicates that a sticker is added to the first video, the material indicated by the editing information may be the sticker.

Optionally, the electronic device may determine the material indicated by the editing information based on any feasible implementation, which is not limited in this disclosure.

Optionally, after the electronic device determines the material indicated by the editing information, the material may be acquired. For example, a plurality of materials may be stored in the electronic device, and the electronic device may acquire, among the plurality of stored materials, a material indicated by the editing information. For example, the electronic device may include material 1, material 2, and material 3, and if the material indicated by the editing information is the material 1 and material 2, the terminal device may acquire the material 1 and material 2, and thus, the efficiency of material acquisition may be improved.

S802, generating the second video based on the editing information, the material, the first video and the audio.

The electronic device generating the second video based on the editing information, the material, the first video and the audio, specifically may be: editing the first video based on the editing information and the material to obtain a third video, and generating the second video based on the third video and the audio.

In some embodiments, the third video may be a video after editing the first video based on the material and the editing information.

Illustratively, if the editing information indicates that the user adds a sticker in a 10 th frame the first video, the electronic device may add the sticker in the 10 th frame of the first video based on the editing information and the sticker, to obtain a third video.

Illustratively, if the editing information indicates that the user adds text in 1 st to 10 th frame of the first video, the electronic device may add the text in the 1 st to 10 th frame of the first video based on the editing information and the text, to obtain a third video.

Illustratively, if the editing information indicates that a filter is added in the first video, a sticker is added in the 10 th frame, and text is added in the 1 st to 10 th frame, the electronic device may add the filter in the first video, add the sticker in the 10 th frame of the first video, and add the text in the 1 st to 10 th frame of the first video, based on the editing information, the filter, the sticker, and the text.

The electronic device may edit the first video based on any feasible implementation, which is not limited in the embodiment of the present disclosure.

Optionally, after determining the third video and the audio, the electronic device may re-encode the third video and the audio to obtain the second video.

Optionally, the electronic device generating the second video based on the third video and the audio, specifically may be: acquiring second information, where the second information includes at least one of: a name of the second video, a length of the second video and a description of the second video, and the electronic device can re-encode the third video and the audio based on the second information to obtain the second video.

In this way, the electronic device can accurately generate the second video based on the second information, and the electronic device can post the edited second video, improving the user experience, and improving the video display effect.

Optionally, the second information may be a data model of the second video constructed by the terminal device, the terminal device may send the data model to the electronic device, and the terminal device may re-encode the third video and the audio based on the data model to obtain the second video.

Optionally, the second information may further include any information used for generating the second video, such as a tag of the second video, a frame rate of the second video, a format of the second video, and an encoding mode of the second video, which is not limited in this embodiment of the present disclosure.

The embodiment of the present disclosure provides a method of generating the second video, where an electronic device may obtain a material indicated by the editing information based on the editing information. the electronic device may edit the first video based on the editing information and the material to obtain a third video, and acquire second information, and the electronic device may re-encode the third video and the audio based on the second information to obtain the second video. In this way, since the second information may include information for generating the second video, the electronic device may accurately generate the second video, and since the third video and the audio are re-encoded at the electronic device, a success rate of re-encoding may be improved, a success rate of video posting may be improved, and the second video may further include editing information of the user, thereby improving a display effect of the second video.

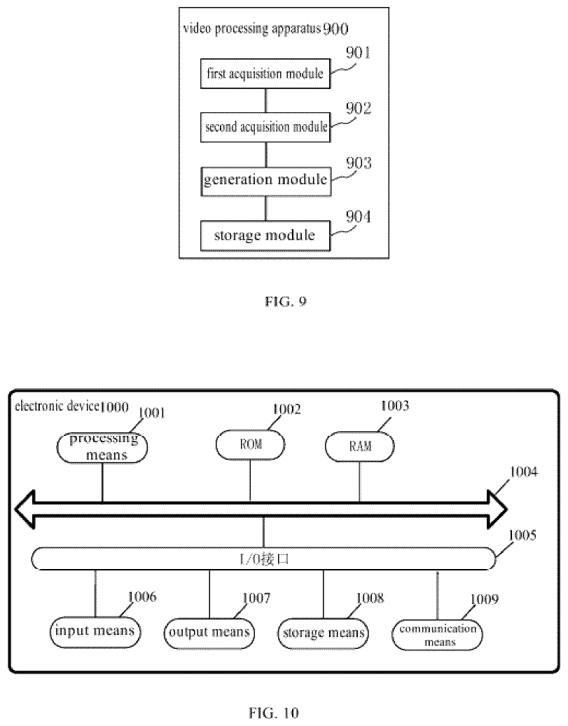

FIG. 9 is a schematic structural diagram of a video processing apparatus according to an embodiment of the present disclosure. Referring to FIG. 9, the video processing apparatus 900 includes a first acquisition module 901, a second acquisition module 902, and a generation module 903, where:
the first acquisition module 901 is configured to acquire a first video and first information, where the first information is used for generating a second video, and the first information includes an identifier of an audio and editing information;
the second acquisition module 902 is configured to acquire the audio in a content delivery network based on the identifier of the audio;
the generation module 903 is configured to generate the second video based on the first video, the audio, and the editing information.

According to one or more embodiments of the present disclosure, the generation module 903 is specifically configured to:
acquire a material indicated by the editing information based on the editing information; and
generate the second video based on the editing information, the material, the first video, and the audio.

According to one or more embodiments of the present disclosure, the generation module 903 is specifically configured to:
edit the first video based on the editing information and the material to obtain a third video; and
generate the second video based on the third video and the audio.

According to one or more embodiments of the present disclosure, the generation module 903 is specifically configured to:
acquire second information, where the second information includes at least one of: a name of the second video, a length of the second video, a description of the second video; and
re-encode the third video and the audio based on the second information to obtain the second video.

According to one or more embodiments of the present disclosure, the material includes one or more of: video, image, audio, sticker, filter, effect, text.

According to one or more embodiments of the present disclosure, the first acquisition module is specifically configured to:
receive a plurality of video segments transmitted by a terminal device and the first information; and
merge the plurality of video segments to obtain the first video.

According to one or more embodiments of the present disclosure, the video processing apparatus 900 further includes a storage module 904 configured to:
store the second video and post the second video.

The video processing apparatus provided in the embodiment of the present disclosure may be configured to implement the technical solutions of the method embodiments, and the implementation principle and the technical effects are similar, which are not described herein again.

FIG. 10 is a schematic structural diagram of an electronic device according to an embodiment the present disclosure. Referring to FIG. 10, a schematic structural diagram of an electronic device 1000 suitable for implementing the embodiments of the present disclosure is shown. Among them, the electronic device may include, but is not limited to, a mobile terminal such as a mobile phone, notebook computer, digital broadcast receiver, Personal Digital Assistant (PDA), Tablet computer, Portable Multimedia Player (PMP), in-vehicle terminal (e.g., in-vehicle navigation terminal), and the like, and a fixed terminal such as a digital TV, desktop computer, and the like. The electronic device shown in FIG. 10 is only an example, and should not bring any limitation to the functions and the scope of use of the embodiments of the present disclosure.

As shown in FIG. 10, the electronic device 1000 may include a processing means (e.g., a central processing unit, a graphics processor, etc.) 1001, which may perform various suitable actions and processes according to a program stored in a Read Only Memory (ROM) 1002 or a program loaded from a storage means 1008 into a Random Access Memory (RAM) 1003. In the RAM 1003, various programs and data necessary for the operation of the electronic device 1000 are also stored. The processing means 1001, ROM 1002, and RAM 1003 are connected to each other by a bus 1004. An input/output (I/O) interface 1005 is also connected to bus 1004.

Generally, the following means may be connected to the I/O interface 1005: an input means 1006 including, for example, a touch screen, touch pad, keyboard, mouse, camera, microphone, accelerometer, gyroscope, and the like; an output means 1007 including, for example, a Liquid Crystal Display (LCD), a speaker, a vibrator, and the like; the storage means 1008 including, for example, magnetic tape, hard disk, and the like; and a communication means 1009. The communications means 1009 may allow the electronic device 1000 to communicate wirelessly or by wire with other means to exchange data. While FIG. 10 illustrates the electronic device 1000 having various means, it is to be understood that not all illustrated means are required to be implemented or provided. More or fewer means may be alternatively implemented or provided.

In particular, the processes described above with reference to the flow diagrams may be implemented as computer software programs, according to the embodiments of the present disclosure. For example, the embodiments of the present disclosure include a computer program product including a computer program embodied on a computer-readable medium, the computer program including program code for performing the method illustrated by the flow diagram. In such an embodiment, the computer program may be downloaded and installed from the network through the communication means 1009, or installed from the storage means 1008, or installed from the ROM 1002. The computer program, when executed by the processing means 1001, performs the above-described functions defined in the methods of the embodiments of the present disclosure.

It should be noted that the computer readable medium of the present disclosure may be a computer readable signal medium or a computer readable storage medium or any combination of the two. The computer readable storage medium may be, for example, but not limited to, an electronic, magnetic, optical, electromagnetic, infrared, or semiconductor system, apparatus, or device, or any combination of the foregoing. More specific examples of the computer readable storage medium may include, but are not limited to: an electrical connection having one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium that can contain, or store a program for use by or in connection with an instruction execution system, apparatus, or device. In contrast, in the present disclosure, the computer readable signal medium may include a propagated data signal with computer readable program code embodied therein, for example, in baseband or as part of a carrier wave. Such a propagated data signal may take any of a variety of forms, including, but not limited to, electro-magnetic, optical, or any suitable combination thereof. The computer readable signal medium may be any computer readable medium that is not the computer readable storage medium and that can communicate, propagate, or transport a program for use by or in connection with an instruction execution system, apparatus, or device. Program code embodied on the computer readable medium may be transmitted using any appropriate medium, including but not limited to: electrical wires, optical cables, RF (radio frequency), etc., or any suitable combination of the foregoing.

The computer readable medium may be embodied in the electronic device; or may be separate and not assembled into the electronic device.

The computer readable medium carries one or more programs which, when executed by the electronic device, cause the electronic device to perform the method shown in the above embodiments.

The embodiments of the present disclosure provide a computer-readable storage medium having stored therein computer-executable instructions which, when executed by a processor, implement the method as described in the above embodiments.

The embodiments of the present disclosure provide a computer program product including a computer program which, when executed by a processor, implements the methods as described in the above embodiments.

Computer program code for carrying out operations of aspects of the present disclosure may be written in any combination of one or more programming languages, including an object oriented programming language such as Java, Smalltalk, C++, and conventional procedural programming languages, such as the “C” language or similar programming languages.

The program code may be executed entirely on the user's computer, partly on the user's computer, as a stand-alone software package, partly on the user's computer and partly on a remote computer or entirely on the remote computer or server. In the scenario where a remote computer is involved, the remote computer may be connected to the user's computer through any type of Network, including a Local Area Network (LAN) or a Wide Area Network (WAN), or may be connected to an external computer (for example, through the Internet using an Internet service provider).

The flow and block diagrams in the figures illustrate the architecture, functionality, and operation of possible implementations of the systems, methods and computer program products according to various embodiments of the present disclosure. In this regard, each block in the flow or block diagrams may represent a module, segment, or portion of code, which includes one or more executable instructions for implementing the specified logical function(s).

It should also be noted that, in some alternative implementations, the functions noted in the block may occur out of the order noted in the figures. For example, two blocks shown in succession may, in fact, be executed substantially concurrently, or the blocks may sometimes be executed in a reverse order, depending upon the functionality involved.

It will also be noted that each block of the block and/or flow diagrams, and combinations of blocks in the block and/or flow diagrams, can be implemented by a special purpose hardware-based system that performs the specified functions or actions, or a combination of special purpose hardware and computer instructions.

The units described in the embodiments of the present disclosure may be implemented by software or hardware. The name of a unit does not in some cases constitute a limitation of the unit itself, for example, a first acquisition unit may also be described as a “unit configured to acquire at least two internet protocol addresses”.

The functions described herein above may be performed, at least in part, by one or more hardware logic components. For example, without limitation, exemplary types of the hardware logic component that may be used include: field Programmable Gate Array (FPGA), Application Specific Integrated Circuit (ASIC), Application Specific Standard Product (ASSP), system on a chip (SOC), Complex Programmable Logic Devices (CPLD), etc.

In the context of this disclosure, the machine-readable medium may be a tangible medium that can contain, or store a program for use by or in connection with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of a machine-readable storage medium would include an electrical connection based on one or more wires, a portable computer diskette, a hard disk, a Random Access Memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing.

It is noted that references to “a” or “an” in this disclosure are intended to be illustrative rather than limiting, and that those skilled in the art will appreciate that references to “one or more” are intended to be exemplary and not limiting unless the context clearly indicates otherwise.

The names of messages or information exchanged between devices in the embodiments of the present disclosure are for illustrative purposes only, and are not intended to limit the scope of the messages or information.

It will be appreciated that the data referred to in this disclosure, including but not limited to the data itself, the acquisition or use of the data, should comply with the requirements of the applicable laws and regulations and related provisions. The data may include information, parameters, messages, etc., such as cut flow indication information.

The foregoing is illustration of the preferred embodiments of the present disclosure and the technical principles employed. It should be appreciated by those skilled in the art that the disclosure scope involved in the present disclosure is not limited to the technical solutions formed by specific combinations of the above technical features, but also encompasses other technical solutions formed by arbitrary combinations of the above technical features or equivalent features thereof without departing from the above disclosed concepts, for example, a technical solution formed by performing mutual replacement between the above features and technical features having similar functions to those disclosed (but not limited to) in the present disclosure.

Furthermore, while operations are depicted in a specific order, this should not be understood as requiring that these operations be performed in the specific order shown or in a sequential order. Under certain circumstances, multitasking and parallel processing may be advantageous. Similarly, while several specific implementation details are included in the above discussion, these should not be construed as limitations on the scope of the present disclosure. Certain features that are described in the context of separate embodiments may also be implemented in combination in a single embodiment. Conversely, various features that are described in the context of a single embodiment may also be implemented in multiple embodiments separately or in any suitable sub-combination. Although the subject matter has been described in language specific to structural features and/or method logical actions, it should be understood that the subject matter defined in the attached claims is not necessarily limited to the specific features or actions described above. Rather, the specific features and actions described above are only example forms of implementing the claims.

What is claimed is

1. A video processing method, comprising:
acquiring a first video and first information, wherein the first information is used for generating a second video, and the first information comprises an identifier of an audio and editing information;
acquiring the audio in a content delivery network based on the identifier of the audio; and
generating the second video based on the first video, the audio, and the editing information.

2. The method according to claim 1, wherein, the generating the second video based on the first video, the audio, and the editing information, comprises:
acquiring a material indicated by the editing information based on the editing information; and
generating the second video based on the editing information, the material, the first video, and the audio.

3. The method according to claim 2, wherein, the generating the second video based on the editing information, the material, the first video, and the audio, comprises:
editing the first video based on the editing information and the material, to obtain a third video; and
generating the second video based on the third video and the audio.

4. The method according to claim 3, wherein, the generating the second video based on the third video and the audio comprises:
acquiring second information, wherein the second information includes at least one of: a name of the second video, a length of the second video, a description of the second video; and
re-encoding the third video and the audio based on the second information, to obtain the second video.

5. The method according to claim 1, wherein, the material comprises one or more of: video, image, audio; sticker, filter, effect, text.

6. The method according to claim 1, wherein, the acquiring a first video and first information, comprises:
receiving a plurality of video segments sent by a terminal device, and the first information; and
merging the plurality of video segments to obtain the first video.

7. The method according to claim 1, wherein, after the generating the second video, the method further comprises:
storing the second video and posting the second video.

8. An electronic device, comprising: a processor and a memory; wherein
the memory stores computer-executable instructions; and
the processor executes the computer-executable instructions stored by the memory, to cause the processor to perform a video processing method, comprising:
acquiring a first video and first information, wherein the first information is used for generating a second video, and the first information comprises an identifier of an audio and editing information;
acquiring the audio in a content delivery network based on the identifier of the audio; and
generating the second video based on the first video, the audio, and the editing information.

9. The device according to claim 8, wherein, the generating the second video based on the first video, the audio, and the editing information, comprises:
acquiring a material indicated by the editing information based on the editing information; and
generating the second video based on the editing information, the material, the first video, and the audio.

10. The device according to claim 9, wherein, the generating the second video based on the editing information, the material, the first video, and the audio, comprises:
editing the first video based on the editing information and the material, to obtain a third video; and
generating the second video based on the third video and the audio.

11. The device according to claim 10, wherein, the generating the second video based on the third video and the audio comprises:
acquiring second information, wherein the second information includes at least one of: a name of the second video, a length of the second video, a description of the second video; and
re-encoding the third video and the audio based on the second information, to obtain the second video.

12. The device according to claim 8, wherein, the material comprises one or more of: video, image, audio, sticker, filter, effect, text.

13. The device according to claim 8, wherein, the acquiring a first video and first information, comprises:
receiving a plurality of video segments sent by a terminal device, and the first information; and
merging the plurality of video segments to obtain the first video.

14. The device according to claim 8, wherein, after the generating the second video; the method further comprises:
storing the second video and posting the second video.

15. A non-transitory computer-readable storage medium having stored therein computer-executable instructions which, when executed by a processor, implement a video processing method, comprising:
acquiring a first video and first information, wherein the first information is used for generating a second video, and the first information comprises an identifier of an audio and editing information;
acquiring the audio in a content delivery network based on the identifier of the audio; and
generating the second video based on the first video, the audio, and the editing information.

16. The non-transitory computer-readable storage medium according to claim 15, wherein, generating the second video based on the first video, the audio, and the editing information, comprises:
acquiring a material indicated by the editing information based on the editing information; and
generating the second video based on the editing information, the material, the first video, and the audio.

17. The non-transitory computer-readable storage medium according to claim 16, wherein, the generating the second video based on the editing information, the material, the first video, and the audio, comprises:
editing the first video based on the editing information and the material, to obtain a third video; and
generating the second video based on the third video and the audio.

18. The non-transitory computer-readable storage medium according to claim 17, wherein, the generating the second video based on the third video and the audio comprises:
acquiring second information, wherein the second information includes at least one of: a name of the second video, a length of the second video, a description of the second video; and
re-encoding the third video and the audio based on the second information, to obtain the second video.

19. The non-transitory computer-readable storage medium according to claim 15, wherein, the material comprises one or more of: video, image, audio, sticker, filter, effect, text.

20. The non-transitory computer-readable storage medium according to claim 15, wherein, the acquiring a first video and first information, comprises:
receiving a plurality of video segments sent by a terminal device, and the first information; and
merging the plurality of video segments to obtain the first video.
